(19) United States
(12) Patent Application Publication
(10) Pub. No.: US 2025/0271813 A1
(43) Pub. Date: Aug. 28, 2025

(54) INTERNAL CHIME MECHANISM FOR AN ALARM CLOCK

(71) Applicant: Nanu Design Inc., San Francisco, CA (US)

(72) Inventors: Andrew Cosgarea, San Francisco, CA (US); Hanna Margaret McPhee, San Francisco, CA (US); Erik Mikael Laukkanen, Sisters, OR (US); Aaron Tyler Nelson, West Linn, OR (US); Jessaca Marie Strayer, San Francisco, CA (US); Ryan Christopher Bahm, San Francisco, CA (US)

(21) Appl. No.: 18/989,574

(22) Filed: Dec. 20, 2024

Related U.S. Application Data
(60) Provisional application No. 63/557,464, filed on Feb. 23, 2024.

(51) Int. Cl. G04C 21/18

(52) U.S. Cl. CPC G04C 21/18

(57) ABSTRACT

An electromechanical chime mechanism includes a chime bar having a plurality of rectangular undercuts and a solenoid striker having a mallet head positioned proximate to and substantially perpendicular to the chime bar. The solenoid striker is (i) positioned within an acoustic resonator and (ii) configured to propel the mallet head against the chime bar when electrically activated. The chime mechanism includes a plurality of shock-absorbing elastic posts with crescent tops holding the chime bar in place. The acoustic resonator is a cavity positioned behind the chime bar with an opening towards the chime bar.

### CROSS-REFERENCE TO RELATED APPLICATIONS

This application claims priority to U.S. Provisional Application Ser. No. 63/557,464, filed Feb. 23, 2024, titled “Internal Chime Mechanism for an Alarm Clock,” which is incorporated by reference herein in its entirety.

### TECHNICAL FIELD

This application relates generally to chime mechanisms, and more specifically to chime mechanisms within limited enclosures.

### BACKGROUND

Many alarm clocks use sounds to wake people from sleep. Typically, the sounds are electronically generated, making loud beeps or buzzing sounds.

### SUMMARY

Disclosed is an alarm clock design featuring a novel compact electromechanical chime mechanism. The chime mechanism includes a rounded rectangular chime bar with a unique cross-sectional design, a solenoid striker with a mallet head, shock-absorbing rubber mounts, and an acoustic resonator configured in a novel arrangement to enhance sound resonance and clarity in a very compact size.

In accordance with some embodiments, an electromechanical chime mechanism includes a chime bar having a plurality of rectangular undercuts (e.g., two or more undercuts) and a solenoid striker having a mallet head positioned proximate to and substantially perpendicular to the chime bar. The solenoid striker is (i) positioned within an acoustic resonator and (ii) configured to propel the mallet head against the chime bar when electrically activated. The acoustic resonator is a cavity positioned behind the chime bar with an opening towards the chime bar.

In accordance with some embodiments, a rectangular chime bar includes a plurality of rectangular undercuts. The chime bar is configured to output sound at a predetermined frequency in response to being struck. A fundamental vibrational mode of the chime bar corresponds to the predetermined frequency. A first position along the longer dimension of the chime bar corresponds to a first node of a fundamental frequency and a second position along the longer dimension of the chime bar corresponds to a second node of the fundamental frequency. The plurality of rectangular undercuts includes a first undercut located at the first position and a second undercut located at the second position.

### BRIEF DESCRIPTION OF THE DRAWINGS

For a better understanding of the various embodiments, review the Description of Embodiments below together with the following drawings. When a reference numeral is used in multiple drawings, it represents the same element in each place it is used.

FIG. 1A is a perspective exterior view of an alarm clock in accordance with some embodiments.

FIG. 1B is the same perspective view of the alarm clock as shown in FIG. 1A, but with exterior portions of the alarm clock shown as transparent, in accordance with some embodiments.

FIG. 1C is a close-up perspective view of the alarm clock shown in FIG. 1A, with the front face removed and other exterior portions shown as transparent, in accordance with some embodiments.

FIG. 1D is a top view of the alarm clock shown in FIG. 1A, with the exterior portion shown as transparent, in accordance with some embodiments.

FIG. 1E is a side view of the alarm clock shown in FIG. 1A, with exterior portions shown as transparent, in accordance with some embodiments.

FIG. 2A is the same perspective view of the alarm clock as shown in FIG. 1B, with some components removed to visualize the chime bar and shock absorbing mounts inside the alarm clock, in accordance with some embodiments.

FIG. 2B is the same top view of the alarm clock as shown in as FIG. 1D, with some components removed to visualize the chime bar, solenoid striker, and shock absorbing mounts inside the alarm clock, in accordance with some embodiments.

FIG. 2C is the same side view of the alarm clock as shown in as FIG. 1E, with some components removed to visualize the chime bar, solenoid striker, and shock absorbing mounts inside the alarm clock, in accordance with some embodiments.

FIG. 3A is a perspective view of the chime bar, in accordance with some embodiments.

FIG. 3B is a side view of the chime bar shown in FIG. 3A, in accordance with some embodiments.

FIG. 3C is a front view of the chime bar shown in FIG. 3A, in accordance with some embodiments.

FIG. 3D illustrates a fundamental mode of the chime bar, in accordance with some embodiments.

FIG. 4A is a perspective view of a mounting post and shock absorbing mounts, in accordance with some embodiments.

FIG. 4B is a front view of the mounting post and shock absorbing mounts shown in FIG. 4A, in accordance with some embodiments.

FIG. 4C is a back view of the mounting post and shock absorbing mounts shown in FIG. 4A, in accordance with some embodiments.

FIG. 4D is a side view of the mounting post and shock absorbing mounts shown in FIG. 4A, in accordance with some embodiments.

FIG. 5 illustrates a position at which the chime bar shown in FIG. 3A is struck, in accordance with some embodiments.

### DESCRIPTION OF EMBODIMENTS

In the following detailed description, numerous specific details are set forth in order to provide a thorough understanding of the various described embodiments. However, the various described embodiments may be practiced without these specific details. In some instances, well-known methods, procedures, and/or components have not been described in detail so as not to unnecessarily obscure aspects of the embodiments.

The terms “first” and “second” may be used to distinguish one element from another, without implying order. For example, a first contact could be termed a second contact or a second contact could be termed a first contact. The first contact and the second contact are both contacts, but they are not the same contact, unless the context clearly indicates otherwise.

The terminology used here describes particular embodiments and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” specify the presence of stated features, steps, operations, elements, and/or components, but do not preclude the presence or addition of one or more other features, steps, operations, elements, components, and/or groups thereof.

While certain materials are sometimes specified, the disclosed devices are not limited to these example materials. Plastics, rubbers, metals, woods, and other materials may comprise some or all of the elements of the various embodiments.

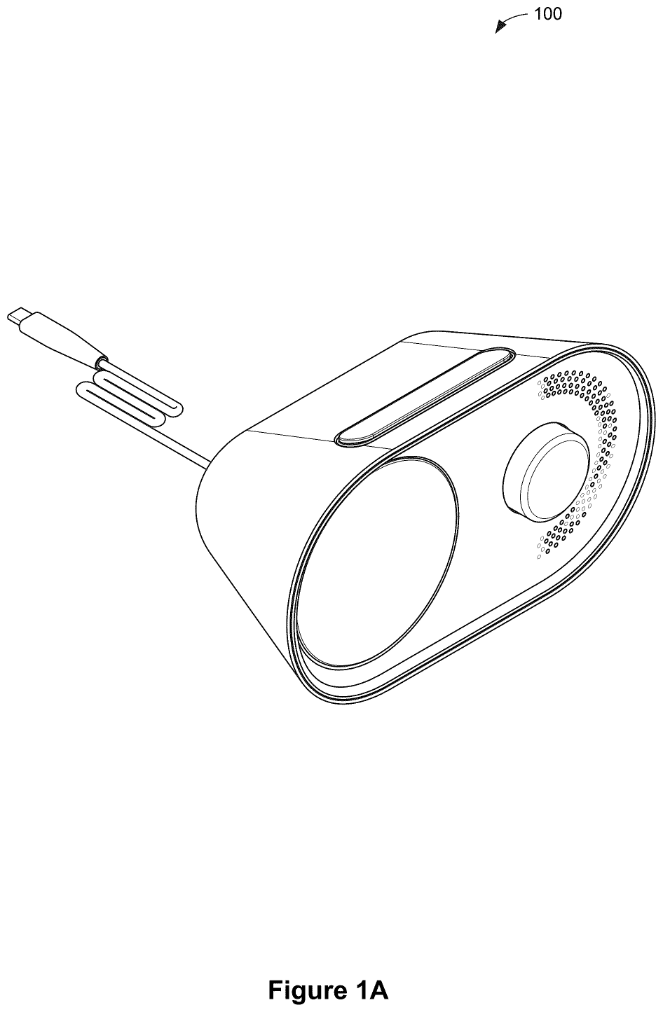

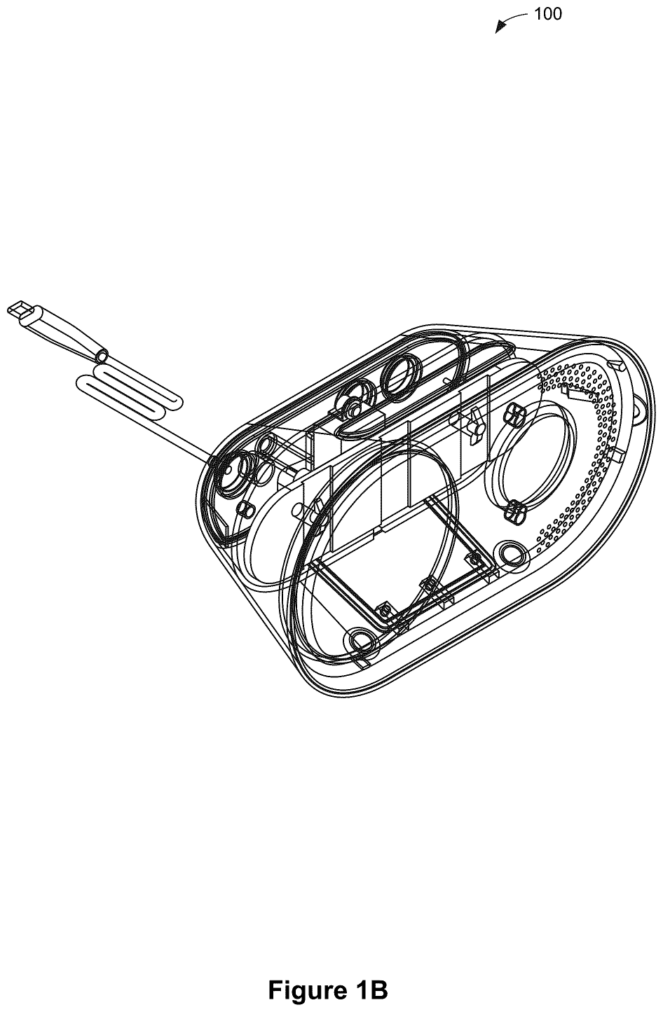

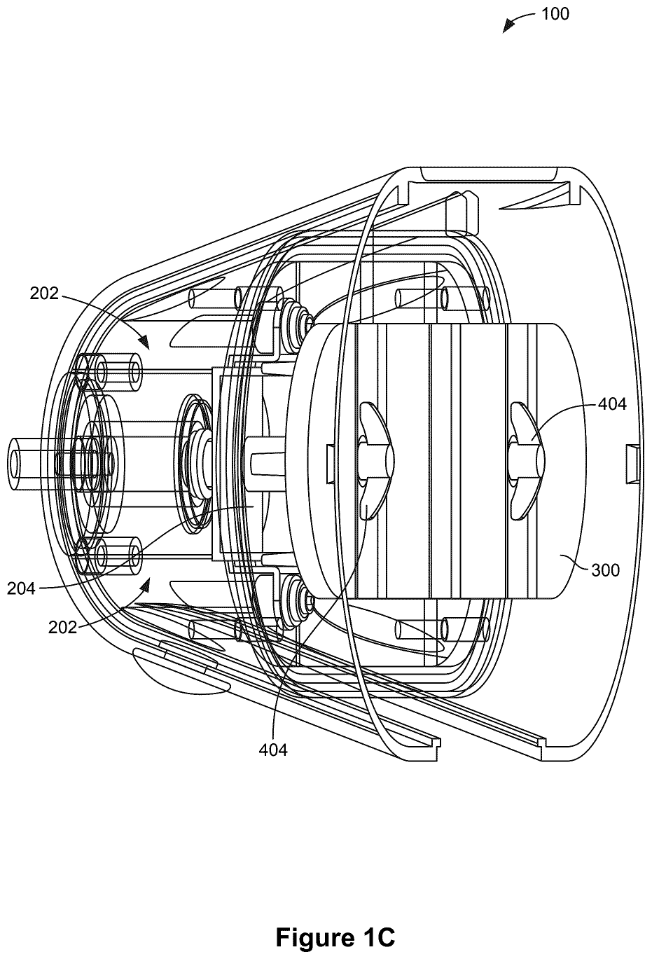

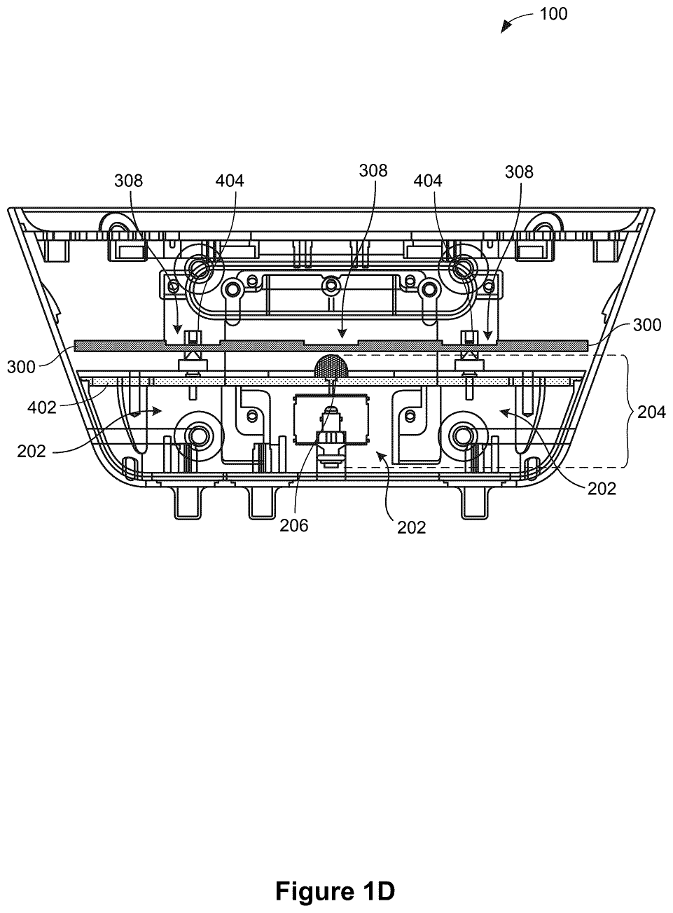

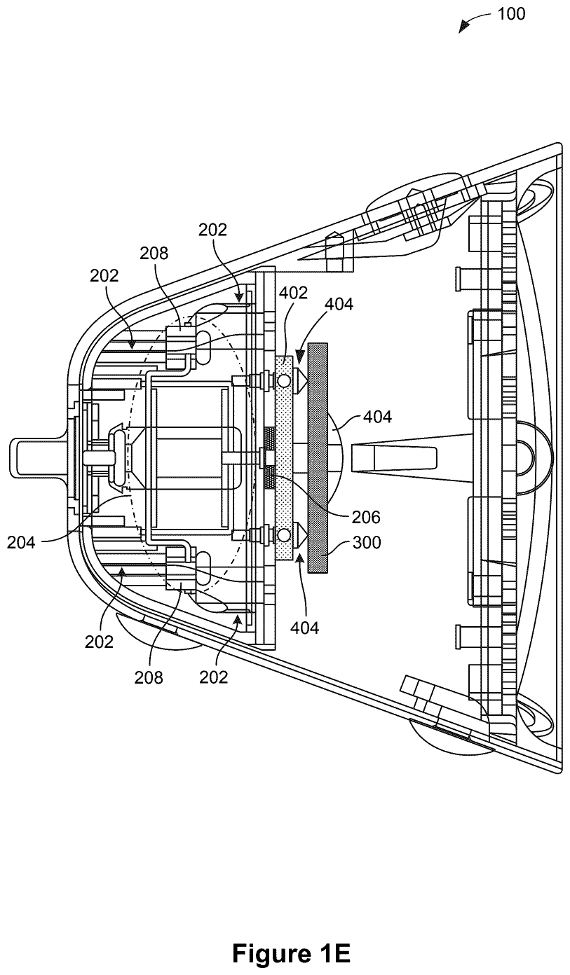

FIG. 1A is a perspective exterior view of an alarm clock, in accordance with some embodiments. FIGS. 1B-1E show the alarm clock 100, but with exterior portions of the alarm clock shown as transparent. FIGS. 1B and IC are perspective views of the alarm clock 100, FIG. 1D is a top view of the alarm clock 100, and FIG. 1E is a side view of the alarm clock 100.

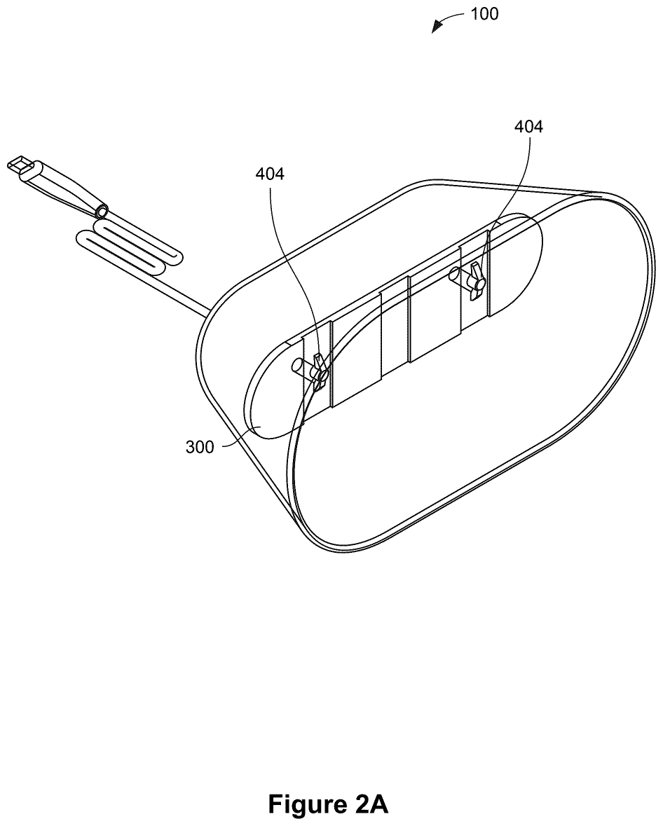

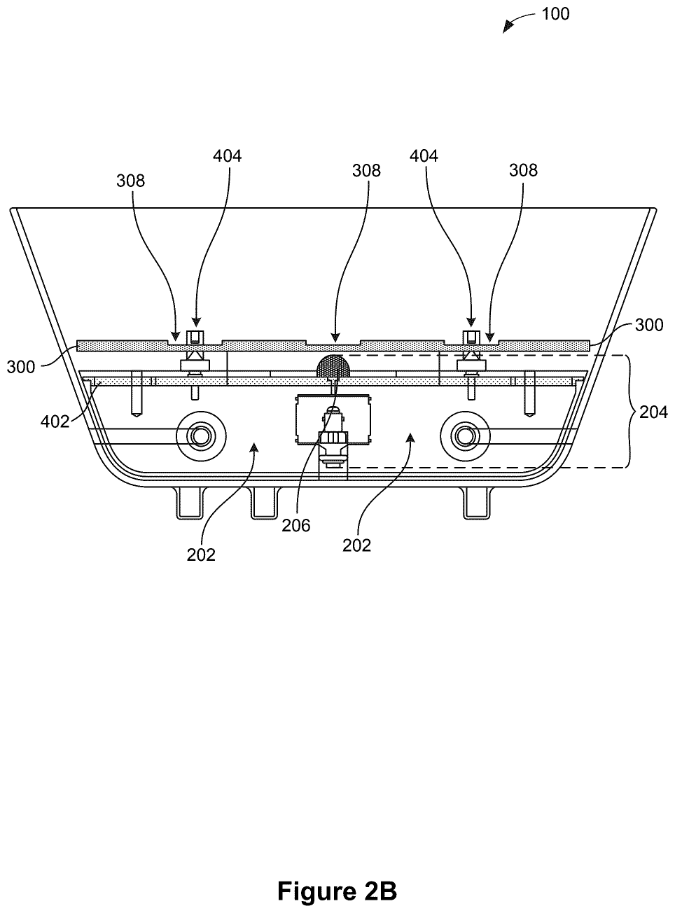

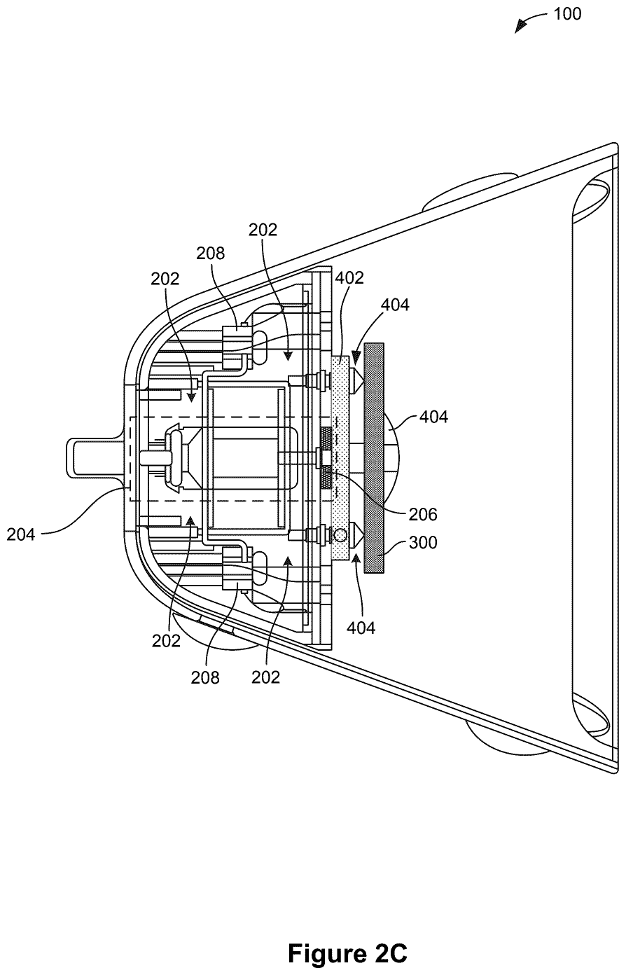

As shown in FIGS. 1B-1E, the alarm clock 100 includes a chime bar 300 configured to emit (e.g., output or produce) a sound (e.g., ring or chime) at a predetermined frequency when struck. In some embodiments, the chime bar 300 (illustrated in FIGS. 1D and 1E with medium shading for ease of reference) is struck with a mallet head 206 (illustrated in FIGS. 1D and 1E with dark shading for ease of reference) that is propelled by a solenoid striker 204. The chime bar 300 is configured to emit sound in response to being struck by the mallet head 206, providing an alarm sound for the alarm clock 100. Details regarding the components of the alarm clock 100 and their functionality are described below with respect to FIGS. 2A-2C.

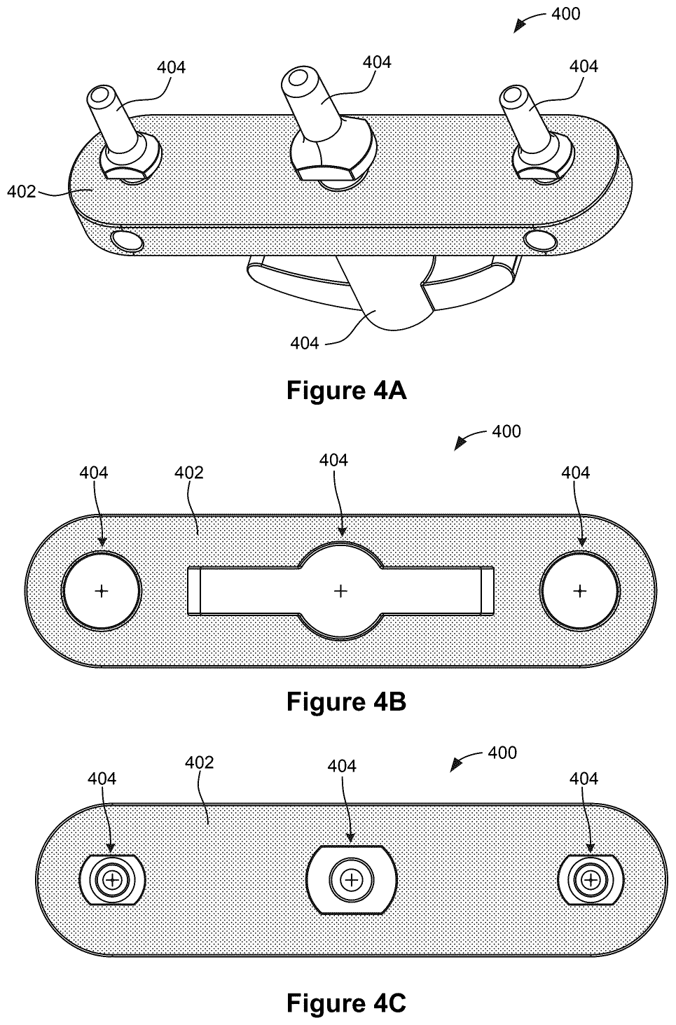

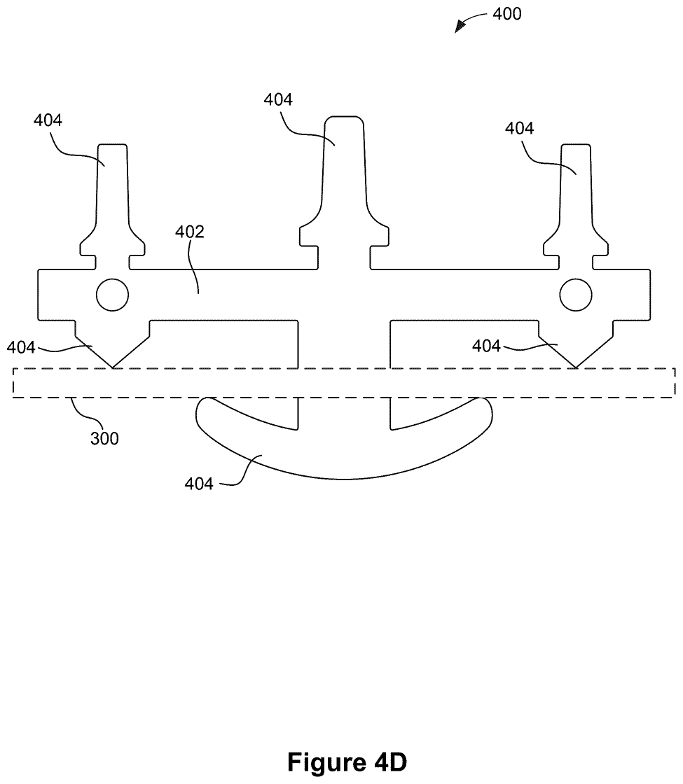

FIGS. 2A-2C illustrate the alarm clock 100, but with exterior portions of the alarm clock shown as transparent and with some components removed so that the chime bar 300, the solenoid striker 204, and the mounting apparatus 400 (as shown in FIG. 4A, including the mounting post 402 and the shock absorbing mounts 404) can be clearly visualized. FIG. 2A shows the same perspective view as FIG. 1B, FIG. 2B shows the same top view as FIG. 1D, and FIG. 2C shows the same side view as FIG. 1E.

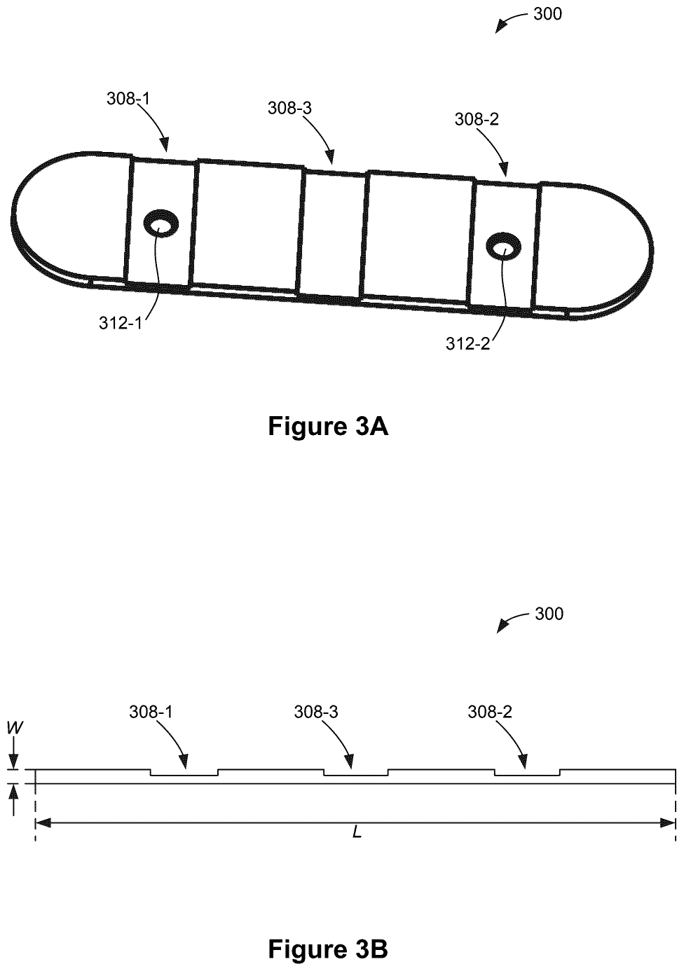

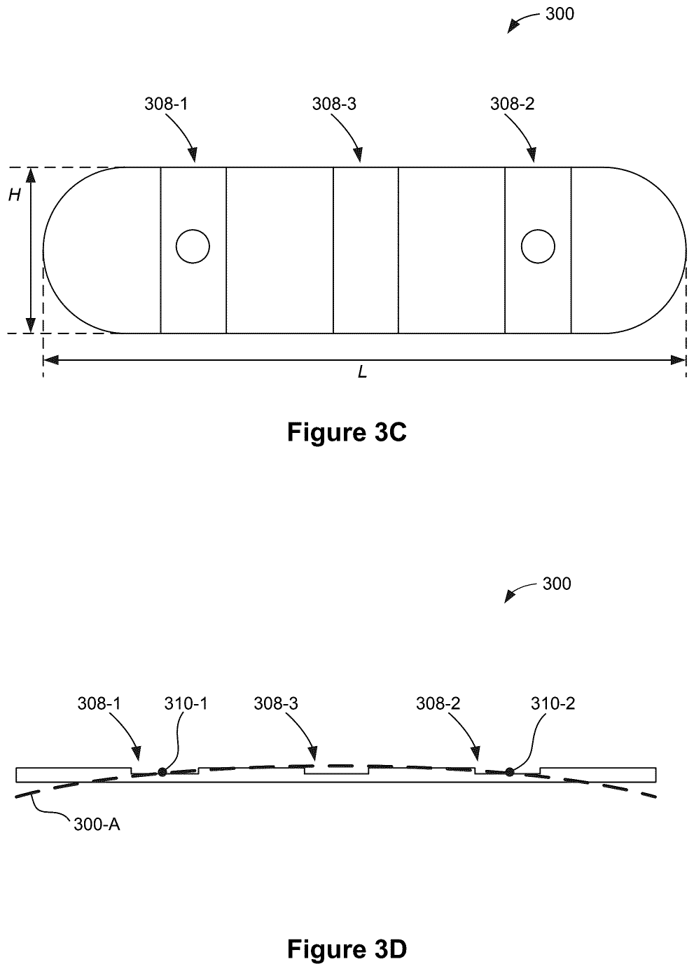

The alarm clock 100 includes an acoustic resonator 202 (also referred to herein as a resonator 202), a solenoid striker 204, a chime bar 300, and a mounting apparatus 400 (sec, e.g., FIG. 4A) for the chime bar 300. The chime bar 300 (illustrated in FIGS. 2B and 2C with medium shading for case of reference) is configured to emit a sound (e.g., ring or chime) at a predetermined frequency when struck. Details regarding the chime bar 300 are provided below with respect to FIGS. 3A-3D. The mounting apparatus 400 is configured to maintain the chime bar's position while ensuring that its natural vibration is not hindered. A mounting post 402 of the mounting apparatus 400 is illustrated in FIGS. 2B and 2C with light shading for ease of reference. Details regarding the mounting apparatus 400 are provided below with respect to FIGS. 4A-4D. The solenoid striker 204 is configured to propel the mallet head 206 (illustrated in FIGS. 2B and 2C with dark shading for case of reference) to strike the chime bar 300, and the resonator 202 is configured to amplify sounds emitted from the chime bar 300.

In some embodiments, as shown in FIGS. 1B-1E and 2A-2C, the resonator 202 is an acoustic cavity positioned behind the chime bar 300 with an opening towards the chime bar 300. This design allows sound waves generated by the chime bar 300 to enter and resonate within the cavity, amplifying the sound in a manner that highlights the desired musical notes while dampening unwanted vibrations.

In some embodiments, as shown in FIGS. 1B-1E and 2A-2C, the solenoid striker 204 (also referred to as a solenoid mechanism or solenoid) is positioned within the acoustic resonator 202. The solenoid striker 204 utilizes an electrically activated solenoid 204 to propel a mallet head 206 against the chime bar 300. In some embodiments, the mallet head 206 is positioned proximate to and substantially perpendicular (e.g., +/−3 degrees, +/−4 degrees, +/−5 degrees, +/−10 degrees, or +/−15 degrees) to the chime bar 300.

in

This unique configuration contrasts with conventional mechanisms where the striker typically impacts the chime bar 300 from an external position relative to the resonator 202. This internal placement is partially motivated by the compact design requirements of the alarm clock 100. Housing the solenoid striker 204 within the resonator 202 introduces unique acoustic challenges. Among the challenges are the amplification of mechanical noise generated by the solenoid striker 204 itself, which muddles the clarity of the chime sound output from the chime bar 300. To mitigate the unintended amplification of mechanical noise, the solenoid striker 204 is mounted on specialized stops 208, which are made of an elastic material, such as rubber or similar material. These stops 208 act as vibration dampeners, absorbing and minimizing the transmission of vibrational energy from the solenoid striker 204 to the resonator 202. Additionally, viscous grease is applied to the actuator of the solenoid striker 204. This grease serves a dual purpose: it lubricates moving parts to reduce friction and wear, and it dampens sounds (e.g., mechanical sounds) created by the actuator's movement.

FIGS. 3A-3D show the chime bar 300, in accordance with some embodiments. FIG. 3A is a perspective view of the chime bar 300, FIG. 3B is a side view of the chime bar 300, and FIG. 3C is a front view of the chime bar 300. FIG. 3D illustrates a fundamental mode of the chime bar 300.

The chime bar 300 is configured to emit sound at a predetermined frequency that is lower than the frequency output from a musical bar composed of the same material as the chime bar 300 and having the same outer dimensions as the chime bar 300. This is accomplished by the use of one or more undercuts 308. The chime bar 300 may include any number of undercuts 308. The undercuts 308 are most easily seen in FIGS. 3A and 3B.

In some embodiments, such as shown in FIGS. 3A-3D, the chime bar 300 possesses a unique cross section incorporating three undercuts 308-1, 308-2, and 308-3 (also referred to collectively as undercuts 308). This design allows the chime bar 300 to vibrate at a desired musical frequency while having a significantly smaller size than conventional musical bars of the same frequency. In some embodiments, there are fewer or more undercuts. In some embodiments, the undercuts 308 are square. In some embodiments, the undercuts 308 are rectangular without being square. In some embodiments, the undercuts have edges that are nonlinear (e.g., circular, elliptical, or parabolic) or having portions that are nonlinear.

FIG. 3D illustrates a position 300-A (shown as a thick dashed line) of the chime bar 300 when it is oscillating at the fundamental mode (e.g., the fundamental vibrational mode, sometimes annotated as n=1 or f₁) of the chime bar 300. The fundamental mode determines the frequency of sound produced by the chime bar 300, and the fundamental mode of the chime bar 300 depends on: (i) the density and (ii) the elasticity of the material from which the chime bar 300 is made, as well as (iii) the length (e.g., long dimension) of the chime bar 300. As shown in FIG. 3D, the fundamental mode has two nodes 310-1 and 310-2, which correspond to positions along the length of the chime bar 300 that do not move (e.g., have an amplitude of zero) during oscillation of the chime bar 300. In some embodiments, the nodes are located at substantially the center (in the short direction, H) of the chime bar 300.

In some embodiments, the chime bar 300 is made of aluminum (e.g., Aluminum 6063). In some embodiments, the chime bar 300 is made of a material having a density that is substantially 2.7 grams/centimeter³ (g/cm³) (e.g., +/−0.3 g/cm³) and having an elasticity modulus that is substantially 68.9 GigaPascals (GPa) (e.g., +/−1 GPa). In some embodiments, the chime bar 300 has a length L (e.g., the long dimension) that is no greater than 147 mm, a height H (e.g., the short dimension) that is no greater than 38 mm, and a width W (e.g., the thickness) that is no greater than 3.1 mm. An equivalent musical bar (e.g., constructed out of the same material and having the same outer dimensions) that does not include undercuts (e.g., a solid bar with no undercuts) would produce a sound that has a higher frequency than the predetermined frequency of the chime bar 300. In some embodiments, the chime bar 300 is configured to produce a B4 note (e.g., the middle B note) having a frequency of 493.883 Hz +/−10 cents (“cents” is the well-known logarithmic unit of measurement to describe musical intervals). In some embodiments, the chime bar 300 is configured to produce sound having a frequency within the range of 491 Hz-495 Hz.

For example, an equivalent musical bar (e.g., constructed out of the same material and having the same outer dimensions) that does not include undercuts (e.g., a solid bar with no undercuts) would produce sound around 790 Hz +/−10 cents.

In another example, a musical bar composed of the same material as the chime bar 300 and having no undercuts has outer dimensions of approximately 45 cm×3.5 cm×3 mm (L×H×W) to produce the B4 note (e.g., to produce sound around 493.883 Hz or to produce sound within the range of 491 Hz-495 Hz). The chime bar 300 has a significantly reduced length in comparison to the length of this example musical bar (L<15 cm for the chime bar 300 compared to L˜45 cm for the example musical bar with no undercuts).

In some embodiments, the undercuts 308 are located at predetermined positions. In some embodiments, as shown in FIG. 3D, a first undercut 308-1 of the chime bar 300 is located at the first node 310-1 of the fundamental mode of the chime bar 300 (e.g., at least a portion of the first undercut 308-1 overlaps with the position of the first node 310-1), and a second undercut 308-2 of the chime bar 300 is located at a second node 310-2 of the fundamental mode of the chime bar 300 (e.g., at least a portion of the second undercut 308-2 overlaps with the position of the second node 310-2). In some embodiments, the chime bar 300 includes a third undercut 308-3 that is located at a node of the second harmonic of the chime bar 300. The second harmonic of the chime bar 300 contributes to the sound (e.g., frequencies) produced by the chime bar 300. The second harmonic of the chime bar 300 depends on the fundamental mode of the chime bar 300. Thus, it also depends on the density and elasticity of the material from which the chime bar 300 is made, as well as the length L (e.g., the long dimension) of the chime bar 300.

In some embodiments, the chime bar 300 includes two mounting holes configured to allow the chime bar 300 to be positioned by the mounting apparatus 400. In some embodiments, the first mounting hole 312-1 is located at the first undercut 308-1 and the second mounting hole 312-2 is located at the second undercut 308-2. The mounting holes can be seen in FIGS. 3A and 3C. In some embodiments, the first mounting hole 312-1 is located at the first node 310-1 of the fundamental mode of the chime bar 300 (e.g., at least a portion of the first mounting hole 312-1 overlaps with the position of the first node 310-1), and the second mounting hole 312-2 is located at the second node 310-2 of the fundamental mode of the chime bar 300 (e.g., at least a portion of the second mounting hole 312-2 overlaps with the position of the second node 310-2).

FIGS. 4A-4D show a mounting apparatus 400, which includes a mounting post 402 and shock absorbing mounts 404, in accordance with some embodiments. FIG. 4A is a perspective view of the mounting post 402 and shock absorbing mounts 404, FIG. 4B is a front view of the mounting post and shock absorbing mounts, and FIG. 4C is a back view of the mounting post and shock absorbing mounts. FIG. 4D is a side view of the mounting post 402 and shock absorbing mounts 404, and illustrates the position of the mounting post 402 and shock absorbing mounts 404 relative to the chime bar 300 (shown in FIG. 4D as a dashed rectangle).

The mounting apparatus 400 includes a plurality of shock absorbing mounts 404 that are fixed to the mounting post 402 (shown in FIGS. 4A-4C with shading). The shock absorbing mounts 404 are constructed of (e.g., made of, composed of) an elastic material such as rubber or a similar material. To position the chime bar 300, a first shock absorbing mount of the mounting apparatus 400 is seated in the first mounting hole 312-1 (shown in FIG. 3A) and a second shock absorbing mount is seated in the second mounting hole 312-2 (shown in FIG. 3A). Thus, the chime bar 300 is mounted via the shock-absorbing mounts 404. These shock-absorbing mounts 404 are specifically engineered to tightly control the chime bar's position while ensuring that its natural vibration is not hindered. In some embodiments, the shock-absorbing mounts 404 are precisely positioned at the chime bar's nodes 310-1 and 310-2 (shown in FIG. 3D), ensuring that they do not interfere with the chime bar's natural vibrations. Upon the chime bar 300 being struck, the crescent moon geometry of the upper shock-absorbing mounts 404 allows the shock-absorbing mounts 404 to compress slightly, letting the chime bar 300 move in response to the impact. This movement creates a clearer sound due to the more elastic nature of the collision compared to having a chime bar 300 mounted using a more rigid material. After the impact at the chime bar 300, the elastic properties of the material of the shock-absorbing mounts 404 (e.g., rubber or a similar material) ensure that the chime bar 300 returns to its original position, ready for the next strike. This recovery is important: if the chime bar 300 were to remain displaced, subsequent strikes by the mallet head 206 (of the solenoid striker 204) would fail to connect with the chime bar 300, compromising the alarm's effectiveness. In some embodiments, the mounting post 402 is constructed from a material different from the shock absorbing mounts 404 (e.g., the mounting post is constructed from a rigid material in some embodiments).

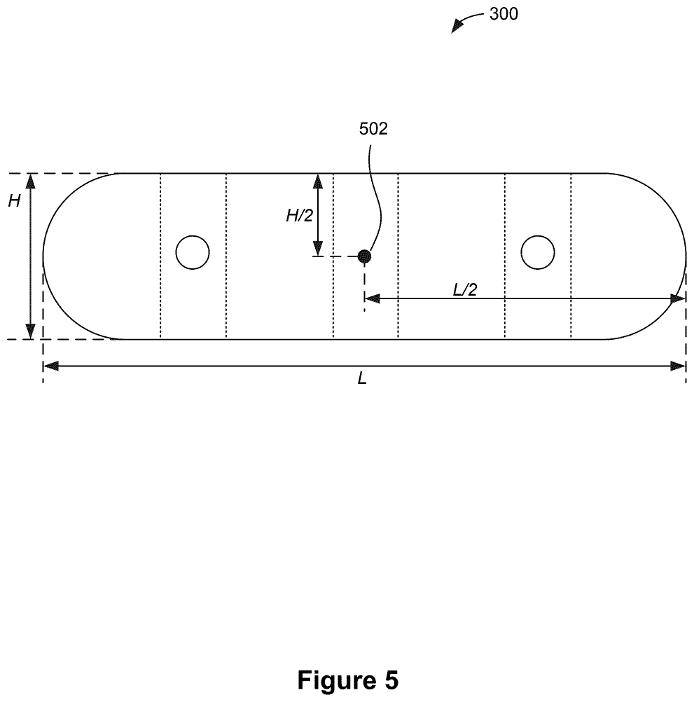

FIG. 5 illustrates the position 502 at which the chime bar 300 shown in FIG. 3A is struck by the mallet head 206, in accordance with some embodiments. The solenoid striker 204 and mallet head 206 are precisely positioned so that the mallet head 206 contacts (e.g., strikes, hits) the chime bar 300 at substantially the center 502 of the chime bar 300 (e.g., +/−2 mm along the short direction of the chime bar 300 and +/−2 mm along the long direction of the chime bar 300). The center 502 (e.g., geometric center) of the chime bar 300 is shown in FIG. 5 as a block dot. Striking the chime bar 300 at an off centered position may excite torsional vibration modes that result in reduced quality in the sound produced by the chime bar 300. In some embodiments, the mallet head 206 strikes the chime bar 300 on the side of the chime bar 300 that does not include the undercuts 308. Thus, FIG. 5 shows the position of the undercuts 308 as dotted lines since the undercuts are located on the opposite side of the chime bar 300 as shown in FIG. 5.

Turning now to some embodiments.

(A1) An electromechanical chime mechanism includes a chime bar having a plurality of rectangular undercuts and a solenoid striker. The solenoid striker has a mallet head that is positioned proximate to and substantially perpendicular to the chime bar. The solenoid striker is (i) positioned within an acoustic resonator and (ii) configured to propel the mallet head against the chime bar when electrically activated. The acoustic resonator is a cavity positioned behind the chime bar with an opening towards the chime bar.

(A2) The electromechanical chime mechanism of A1, where the chime bar has a first node and a second node that is distinct from the first node. The first node and the second node correspond to a fundamental vibrational mode of the chime bar. The plurality of rectangular undercuts includes a first rectangular undercut and a second rectangular undercut that is distinct from the first rectangular undercut. The first rectangular undercut is located at a first position that overlaps with the first node and the second rectangular undercut is located at a second position that overlaps with the second node.

(A3) The electromechanical chime mechanism of A2, where a plurality of shock-absorbing elastic posts have crescent tops holding the chime bar in place. The plurality of shock-absorbing elastic posts includes a first shock absorbing post and a second shock absorbing post that is distinct from the first shock absorbing post. The first shock absorbing post is positioned at the first position and the second shock absorbing post is positioned at the second position.

(A4) The electromechanical chime mechanism of any of A1-A3, where the mallet head is positioned relative to the chime bar such that the mallet head contacts the chime bar substantially at a center along a short dimension of the chime bar.

(A5) The electromechanical chime mechanism of any of A1-A4, where the mallet head is positioned relative to the chime bar such that the mallet head contacts the chime bar substantially at a center along a long dimension of the chime bar.

(A6) The electromechanical chime mechanism of any of A1-A5, where the chime bar is configured to, when struck by the mallet head, output sound at a predetermined frequency that is lower than a natural frequency of a bar that (i) is composed of a material having a substantially similar density and a substantially similar elasticity as a material of the chime bar and (ii) has the same outer dimensions as the chime bar.

(A7) The electromechanical chime mechanism of any of A1-A6, where the chime bar has outer dimensions that are no greater than 3.1 mm in thickness, 147 mm in length, and 38 mm in width.

(A8) The electromechanical chime mechanism of any of A1-A7, where the chime bar is composed of a material having a density no greater than 2.8 g/cm³.

(A9) The electromechanical chime mechanism of any of A6-A8, where the predetermined frequency substantially corresponds to a B4 note.

(A10) The electromechanical chime mechanism of any of A1-A9, further including a plurality of shock-absorbing elastic posts with crescent tops holding the chime bar in place.

(A11) The electromechanical chime mechanism of A10, where the shock-absorbing elastic posts are configured to hold the chime bar in place while allowing the chime bar to vibrate freely.

(A12) The electromechanical chime mechanism of any of A1-A11, where the chime bar has a rounded rectangular shape.

(B1) A rectangular chime bar includes a plurality of rectangular undercuts. The chime bar is configured to output sound at a predetermined frequency in response to being struck. A fundamental vibrational mode of the chime bar corresponds to the predetermined frequency. A first position along a long dimension of the chime bar corresponds to a first node of a fundamental frequency and a second position along the long dimension of the chime bar corresponds to a second node of the fundamental frequency and the plurality of rectangular undercuts includes a first undercut located at the first position and a second undercut located at the second position.

(B2) The rectangular chime bar of B1, where the predetermined frequency is lower than a natural frequency of a bar composed of a same material and having same outer dimensions as the chime bar.

The illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An electromechanical chime mechanism comprising:
a chime bar having a plurality of rectangular undercuts; and
a solenoid striker having a mallet head positioned proximate to and substantially perpendicular to the chime bar, wherein the solenoid striker is (i) positioned within an acoustic resonator and (ii) configured to propel the mallet head against the chime bar when electrically activated, and wherein the acoustic resonator is a cavity positioned behind the chime bar with an opening towards the chime bar.

2. The electromechanical chime mechanism of claim 1, wherein:
the chime bar has a first node and a second node that is distinct from the first node;
the first node and the second node correspond to a fundamental vibrational mode of the chime bar;
the plurality of rectangular undercuts includes a first rectangular undercut and a second rectangular undercut that is distinct from the first rectangular undercut;
the first rectangular undercut is located at a first position that overlaps with the first node; and
the second rectangular undercut is located at a second position that overlaps with the second node.

3. The electromechanical chime mechanism of claim 2, further comprising:
a plurality of shock-absorbing elastic posts with crescent tops holding the chime bar in place, wherein:
the plurality of shock-absorbing elastic posts includes a first shock absorbing post and a second shock absorbing post that is distinct from the first shock absorbing post;
the first shock absorbing post is positioned at the first position; and
the second shock absorbing post is positioned at the second position.

4. The electromechanical chime mechanism of claim 1, wherein the mallet head is positioned relative to the chime bar such that the mallet head contacts the chime bar substantially at a center along a short dimension of the chime bar.

5. The electromechanical chime mechanism of claim 1, wherein the mallet head is positioned relative to the chime bar such that the mallet head contacts the chime bar substantially at a center along a long dimension of the chime bar.

6. The electromechanical chime mechanism of claim 1, wherein the chime bar is configured to, when struck by the mallet head, output sound at a predetermined frequency that is lower than a natural frequency of a bar that (i) is composed of a material having a substantially similar density and a substantially similar elasticity as a material of the chime bar and (ii) has the same outer dimensions as the chime bar.

7. The electromechanical chime mechanism of claim 6, wherein the chime bar has outer dimensions that are no greater than 3.1 mm, 147 mm, and 38 mm.

8. The electromechanical chime mechanism of claim 6, wherein the chime bar is composed of a material having a density no greater than 2.8 g/cm³.

9. The electromechanical chime mechanism of claim 6, wherein the predetermined frequency substantially corresponds to a B4 note.

10. The electromechanical chime mechanism of claim 1, further comprising a plurality of shock-absorbing elastic posts with crescent tops holding the chime bar in place.

11. The electromechanical chime mechanism of claim 10, wherein the shock-absorbing elastic posts are configured to hold the chime bar in place while allowing the chime bar to vibrate freely.

12. The electromechanical chime mechanism of claim 1, wherein the chime bar has a rounded rectangular shape.

13. A rectangular chime bar comprising:
a plurality of rectangular undercuts, wherein:
the chime bar is configured to output sound at a predetermined frequency in response to being struck;
a fundamental vibrational mode of the chime bar corresponds to the predetermined frequency;
a first position along a long dimension of the chime bar corresponds to a first node of a fundamental frequency and a second position along the long dimension of the chime bar corresponds to a second node of the fundamental frequency; and
the plurality of rectangular undercuts includes a first undercut located at the first position and a second undercut located at the second position.

14. The rectangular chime bar of claim 13, wherein:
the predetermined frequency is lower than a natural frequency of a bar composed of a same material and having same outer dimensions as the chime bar.
